(19) United States
(12) Patent Application Publication
(10) Pub. No.: US 2026/0175769 A1
(43) Pub. Date: Jun. 25, 2026

(54) Interior Space Expansion Equipment for Accommodation Facility

(71) Applicant: X GLOO GmbH & Co. KG, Marquartstein (DE)

(72) Inventors: Thomas Allertseder, Marquartstein (DE); Florian Lizba, Marquartstein (DE)

(21) Appl. No.: 19/427,557

(22) Filed: Dec. 19, 2025

(30) Foreign Application Priority Data
Dec. 20, 2024 (DE) 10 2024 139 357.2

(51) Int. Cl. B60P 3/34

(52) U.S. Cl. CPC B60P 3/341

(57) ABSTRACT

The disclosure relates to: an interior space expansion equipment for a vehicle or a trailer, comprising: a movable section, a textile fabric and a toggle lever which, when the movable section is brought into a retracted and/or folded-in position, performs a movement towards a center section or area of the interior space expansion and allows for a movement of the textile fabric towards the center section or area of the interior space expansion; a method of retracting and/or folding in a movable section of an interior space expansion equipment; a use of the interior space expansion equipment; and a vehicle or a trailer comprising the interior space expansion equipment.

### BACKGROUND OF THE INVENTION

### Technical Field

The disclosure relates to an interior space expansion equipment which is arranged or arrangeable on an accommodation facility, preferably a vehicle or a trailer, further preferentially a camper or camper trailer, comprising: a movable section which is capable to be brought both into an extended and/or folded-out position and into a retracted and/or folded-in position, and a textile fabric which, in the extended and/or folded-out position of the movable section, together with the movable section forms/provides an interior space expansion of the accommodation facility.

### Description of Related Art

Interior space expansions for an accommodation facility such as a vehicle or a trailer basically serve to enlarge the usable space of the vehicle (or trailer), while the latter preferably is stationary. Accordingly, the usable space can be interconnected or separated. It is known that a wall section of the interior space expansion can be made of different materials such as metals, plastics, textiles, natural materials, composites, etc., and has either pliable or rigid structures.

From DE 10 2017 206 260 A1 or DE 10 2021 114 464 A1 it is known that rigid wall sections are guided by means of hinge-like connections between them (film hinges) in an origami-like manner. For pliable wall sections it is known in prior art that external scissors-like mechanisms which tension and guide pliable structures while restricting and/or reducing the interior space expansion due to the external position are provided on wall sections. U.S. Pat. No. 7,677,641 B1 discloses such an interior space expansion.

In known wall sections guided in this way and made of pliable structures, frequently the problem arises that, in real boundary conditions, the guide fails and no properly defined end position of the pliable structures can be brought about. In this case, the pliable structures are easily damaged and additionally have to be brought manually into the intended end position. Apart from increased material wear, this results in longer fold-in times of the interior space expansion equipment and thus deteriorates the user experience.

### SUMMARY OF THE INVENTION

Against this background, it is the object of the present disclosure to avoid or at least reduce the above-mentioned drawbacks, and in particular to provide an interior space expansion equipment for an accommodation facility such as a vehicle or a trailer which allows gentle and long-lasting use and a user-friendly experience. In particular, importance is to be attached to sustainability to provide a sustainable interior space expansion equipment.

The object is achieved by an interior space expansion equipment according to claim 1 and by a method of retracting and/or folding in a movable section of an interior space expansion equipment according to claim 13 and by use of an interior space expansion equipment according to claim 14 and by an accommodation facility according to claim 15. Advantageous embodiments are claimed in the subclaims and/or will be explained hereinafter.

The disclosure relates to an interior space expansion equipment which is arranged or arrangeable on an accommodation facility, preferentially a vehicle or a trailer, further preferentially a camper or camper trailer, comprising: a movable section which is capable to be brought both into an extended and/or folded-out position and into a retracted and/or folded-in position; a textile fabric which in the extended and/or folded-out position of the movable section together with the movable section forms/provides an interior space expansion of the accommodation facility; and a toggle lever which is arranged at a corner section of the interior space expansion equipment and, when the movable section is brought into the retracted and/or folded-in position, enables a movement towards a center section or area of the interior space expansion and a movement of the textile fabric towards the center section or area of the interior space expansion, preferably pulls the textile fabric towards the center section or area of the interior space expansion.

The interior space expansion equipment according to the disclosure is prepared and configured to expand/enlarge an interior space. Accordingly, a modular design can be applied, for example. According to the present disclosure, “modular” particularly means that the accommodation facility, preferably the vehicle or the trailer, already exists and the interior space expansion equipment can be retrofitted thereto. This facilitates advantageously a sustainable use, as customized retrofit options are made possible to improve existing accommodation facilities.

The interior space expansion equipment according to the disclosure is arranged or arrangeable on an accommodation facility, preferably on the vehicle or the trailer. Accommodation facilities can be movable or stationary. Stationary accommodation facilities can be huts, container homes or tiny houses. In contrast to that, movable accommodation facilities could be vehicles, trailers or wheeled tiny houses, for example. In this context, the vehicle is not restricted to a camper. The vehicle may be, for example, a van or a mobile home or a camper van. Also, the trailer is not restricted to a camper trailer. For example, the trailer may be a caravan.

According to the disclosure, the interior space expansion equipment can be arranged on a side panel and/or a roof of the accommodation facility and, preferably, on a vehicle/trailer side panel and/or preferably a vehicle/trailer roof and/or preferably a vehicle/trailer rear panel. In this way, advantageously various application options with considerable added value potential can be made possible.

When referring to the movable section according to the disclosure, it is defined as a section which is capable to be brought both into an extended and/or folded-out position and into a retracted and/or folded-in position. In other words, the movable section according to the disclosure, is preferably defined as a section which is configured to be brought/bringable both into an extended and/or folded-out position and into a retracted and/or folded-in position. Such a movable section can be a part of or the entirety of the accommodation facility side panel, the accommodation facility roof and, preferentially, the vehicle/trailer side panel, preferentially the vehicle/trailer roof, or preferentially the vehicle/trailer rear panel. In particular, the movable section is a panel/roof section which is or can be attached to the accommodation facility side panel, the accommodation facility roof or, preferentially, the vehicle/trailer roof or, preferentially, the vehicle/trailer rear panel and, together with further elements and components constitutes the interior space expansion equipment according to the disclosure.

In accordance with the disclosure, the extended and/or folded-out position is defined as a predetermined position which is reached when the interior space expansion equipment expands or enlarges the interior space. In contrast to that, the interior space is preferably not expanded or enlarged, when the movable section of the interior space expansion equipment assumes the retracted and/or folded-in position which preferably is also a predetermined position.

When lifted on one side only, the movable section can basically describe, according to the disclosure, a pure rotational movement about an opposite side. Following the same logic, the movable section can also be lifted at one point only so that a pure rotational movement about an opposite point or about an opposite side may be provided. This case is referred to as folding out in the disclosure. Further, the movable section may also be lifted on two sides or, resp., at four corner points, however. This can ensure a pure translational movement and, according to the disclosure, is referred to as extending. When the two types (folding out and extending) are combined, also combined rotational and translational movements can be allowed.

The movable section of the interior space expansion equipment thus can be provided according to the disclosure to describe an (exclusively) translational extending movement or an (exclusively) rotational folding-out movement or a combined extending and folding-out movement. By the options of combining the various movement components, advantageously a construction space is enlarged, thereby allowing for an attractive design with improved technical benefits at the same time.

When the movable section is extended and/or folded-out, then the interior space is expanded or enlarged. Consequently, extending and/or folding out the movable ection provides the interior space expansion and, resp., an interior enlargement. As a consequence, the interior space expansion can also be referred to as interior space enlargement.

According to the disclosure, the textile fabric is a textile which generally can form two-dimensional surfaces. By the combination of at least one inner layer and one outer layer of a textile fabric, also three-dimensional spaces can be formed, however. This is particularly the case when referring to at least double-walled textile fabrics. They can allow for the capability of being inflated/being filled with a fluid, allowing rigid, specifically non-pliable, structures to be formed. This embodiment is advantageous according to the disclosure as compared to a pliable textile fabric. It is understood that this three-dimensional space formed by a double-walled textile fabric/these three-dimensional spaces formed by a double-walled textile fabric enable, in combination with one another, the space of the interior space expansion, to be spanned, preferentially together with the afore-mentioned movable section. The disclosure is not restricted to providing an inflatable or fillable textile fabric, however. According to the disclosure, the textile fabric can also be a substantially two-dimensional pliable textile.

Advantageously, the textile fabric helps facilitate quick and safe opening and closing of the interior space expansion equipment. It is further mentioned that textile fabrics at the same time convey a nostalgic feeling of traditional and proven camping, while at the same time offering state-of-the-art design with state-of-the-art construction. This increases the users' satisfaction.

When, according to the disclosure, referring to interior space expansion, the latter constitutes an additional volume section or volume area which enlarges an original volume section or volume area inside the accommodation facility and, resp., preferably the vehicle or preferably the trailer. In other words, a total volume results from adding the original volume section to the additional volume section.

The interior space expansion equipment according to the present disclosure comprises a toggle lever. According to the disclosure, a “toggle lever” is particularly a mechanism which comprises at least one upper and one lower toggle lever member which are connected to each other via a positioning guide element, preferably a joint. Such toggle lever can also be referred to as positioning mechanism. Thus, according to the disclosure, a toggle lever in other words in particular is a toggle joint. According to the disclosure, the movement of the toggle lever is limited such that no pure movement in the direction of an edge between two adjacent corner sections of the interior space expansion equipment is allowed. Taking all movement components into account, the resulting direction always is towards the center section or area of the space, for example in such manner that the resulting direction is composed of at least two movement components, namely a first movement component towards a first adjacent corner section and a second movement component towards a second adjacent corner section, viewed from the corner section on which the corresponding toggle lever is arranged, so that no pure movement towards one of the two adjacent corner sections is possible. When illustrated, according to a preferred embodiment this corresponds substantially or approximately to a movement towards the diagonally opposite corner section. In other words, the resulting movement component always faces mainly the direction of the center section or area of the interior space expansion, wherein the resulting movement component does not necessarily have to extend exactly in the direction of the diagonally opposite corner section.

When referring, according to the disclosure, to corner sections, they are generally defined as the corner or edge areas of a cuboid or polyhedron. The connecting line extends perpendicularly from two corners of the cuboid or polyhedron to the base area of the accommodation facility roof and/or the accommodation facility side panel or preferably the vehicle/trailer roof and/or preferably the vehicle/trailer side panel and/or preferably the vehicle/trailer rear panel, and consequently corresponds to a virtual edge so that, according to the disclosure, the corner section substantially is a section or area along said edge. Preferably, the associated toggle lever extends substantially along such a virtual edge. In other words, the position of a toggle lever is substantially or preferentially orthogonal to the associated base area which, when arranging the interior space expansion equipment on the accommodation facility side panel, corresponds to the accommodation facility side panel or to a base area mounted thereon and, when arranging the interior space expansion equipment on the accommodation facility roof, corresponds to the accommodation facility roof or to a base area mounted thereon. Preferentially, when arranging the interior space expansion equipment on the vehicle/trailer side panel, the base area corresponds to the vehicle/trailer side panel or to a base area mounted thereon and, when arranging the interior space expansion equipment on the vehicle/trailer roof, corresponds to the vehicle/trailer roof or to a base area mounted thereon and, when arranging the interior space expansion equipment on the vehicle/trailer rear panel, corresponds to the vehicle/trailer rear panel or to a base area mounted thereon.

It is understood that, according to the disclosure, when the interior space expansion equipment is mounted on an accommodation facility roof, in particular a vehicle/trailer roof, the movable section does not have to extend or be erected in parallel to the accommodation facility roof. In other words, the movable section can be brought into a combined extended and folded-out position and, thus, can form an inclined roof plane of the interior space expansion equipment so that accordingly a polyhedron is formed by the interior space expansion equipment.

Furthermore, it is understood that, according to the disclosure, rectangular base areas are preferred. However, the disclosure is not restricted to that, and any base areas such as any triangular, quadrangular, pentagonal, hexagonal, etc. base areas are conceivable. The toggle levers are arranged also in this case in corner sections of the base areas, in particular in the transition section between two edges of the base area, and move relative to the center section or area, particularly preferred but not necessarily along a bisecting line between the two edges of the base area.

When referring, according to the disclosure, to the center section or area, a volume section/area is meant which is located inside the interior space expansion. Said volume section/area does not correspond to the entire volume of the interior space expansion, however, as respective areas near the delimiting surfaces of the wall sections of the interior space expansion equipment formed by the textile fabric are not included. This makes clear that the, now completely written out, center section of space or, resp., center area of space comprises the geometric center of space, but not the area centers of the delimiting surfaces of the panel sections.

The smaller the volume of the center section or area, the more restricted is the direction of movement of the disclosed toggle lever. When, for example, 80% of the volume of the center section or area correspond to the total volume of the interior space expansion, then the freedom or possibility of movement is greater than when the percentage decreases (to 20%, for example). In other words, the movement of the toggle lever corresponds to a movement toward the geometric center of space, when the percentage approaches 0. In yet other words, by excluding the areas near the delimiting surfaces of the panel sections, also a movement along the edges between two corner sections is excluded.

When referring, according to the disclosure, to panel sections, they are defined as the surfaces delimiting the sides of a cuboid. It is understood that plural panel sections, in particular all four panel sections, can be formed by a coherent textile fabric which specifically cannot be separated without destruction and is preferably inflatable and at least double-walled. It is further understood that also plural panel sections, in particular all four panel sections, can be formed by separate, preferably inflatable and at least double-walled, textile fabrics, however.

In a preferred embodiment of the interior space expansion equipment on the accommodation facility side panel or preferentially on the vehicle/trailer side panel and/or preferentially on the vehicle/trailer rear panel, at least one floor element and at least one roof element as well as three panel sections are formed by folding out/extending the movable section. In other words, the missing fourth panel section can form a connection to the accommodation facility interior space and, resp., preferentially to the vehicle/trailer interior space. Of preference, at least two panel sections feature the textile fabric, in particular the at least double-walled inflatable textile fabric, as material, and most preferentially the panel section parallel to the accommodation facility side panel, particularly to the vehicle/trailer side panel or to the vehicle/trailer rear panel, forms the movable section according to the disclosure which can be brought into the folded-out/extended position, while the floor element, the roof element and two of the three panel sections are formed by the textile fabric, on the other hand.

In a different preferred embodiment of the interior space expansion equipment on the accommodation facility roof, preferentially on the vehicle/trailer roof, wall sections, particularly four wall sections, are equally formed by folding out/extending the movable section, wherein the floor comprises specifically a connection to the accommodation facility interior space, and preferentially to the vehicle/trailer interior space, in particular by means of cutouts to the accommodation facility interior space, and preferentially to the vehicle/trailer interior space. The floor and roof elements preferentially feature a rigid material and the panel sections most preferably include the textile fabric, in particular the at least double-walled inflatable textile fabric as material. According to this embodiment, the roof element constitutes the movable section according to the disclosure.

It is advantageous when the panel sections feature an at least double-walled inflatable textile fabric as material. This allows for sound and temperature insulation, UV and weather resistance, for example. Further, the at least double-walled inflatable textile fabric is low-risk and burglar-proof. Advantageously, this allows for high sleeping comfort, privacy and user friendliness.

The floor element preferably has a rigid material. This allows loads that are introduced by the user/users to be distributed advantageously across defined force application points at the accommodation facility, preferentially at the vehicle or at the trailer, further preferentially at the body and chassis thereof. This prevents damage and allows sustainable use. It is understood that the floor element can be a slatted frame or a frame open to the bottom.

In a further embodiment, the additional floor element is omitted, as it is formed by the already existing structures.

Preferably, the toggle lever is configured and provided according to the disclosure to guide the textile fabric forcibly. In other words, preferentially but not necessarily there is a constant connection between the toggle lever and the textile fabric, preferentially in the corner section of the interior space expansion equipment between two adjacent panel sections of the textile fabric. In yet other words, the textile fabric reacts with a movement, when the toggle lever is moving. This applies primarily both when the movable section is moved to the extended and/or folded-out position and when the movable section is moved to the retracted and/or folded-in position, as well as in all possible intermediate states.

According to the disclosure, the toggle lever can be arranged at the corner section, specifically completely, inside the interior space expansion/in an interior space formed by the interior space expansion equipment/on the inside relative to the textile fabric. In other words, the toggle lever then cannot be seen by an outside observer, provided the enclosing panel sections and the floor and roof elements are opaque. This contributes advantageously to allowing for an appealing design while at the same time position of sensitive components is protected and closed off from the surroundings.

When plural toggle levers are provided, for example at all (four) corner sections of the interior space expansion equipment, preferentially all toggle levers are arranged inside the interior space expansion/in an interior space formed by the interior space expansion equipment/inside in relation to the textile fabric.

When plural toggle levers, such as four toggle levers, are provided each of which is arranged at a corner section of the interior space expansion equipment, preferentially the plural toggle levers perform a movement towards the center section or area of the interior space expansion, when the movable section is brought into the retracted and/or folded-in position, and enable (starting from the corresponding corner section, preferably from all corner sections) a movement of the textile fabric towards the center section or area of the interior space expansion, preferably pull the textile fabric (starting from the corresponding corner section, preferentially from all corner sections) towards the center section or area of the interior space expansion.

The toggle lever according to the disclosure may comprise, when mounted on the accommodation facility roof, a floor guide element which is connected to the floor element facing the accommodation facility, a positioning guide element which particularly comprises the attachment/connection to the textile fabric, a roof guide element which is connected to the roof element facing away from the accommodation facility, a first lower toggle lever member and a second upper toggle lever member. When mounted on the accommodation facility side panel, the toggle lever may comprise the same components, but has to be rotated correspondingly about substantially or approximately 90°. It should be noted that the literal meanings of roof, floor, side, top and bottom have to be adapted, where necessary.

The floor guide element of the toggle lever can be connected advantageously via a frictional or material connection, preferably via an oblong hole to a fastener (e.g. a screw), or to the floor element by welding. Accordingly, it is not excluded that also positive connections are possible. A screwed connection, which can be deemed to be a fastener, for example provides a robust frictional connection due to friction between the fastener and the floor element by existing positive undercuts of the pairing of external and internal threads. An oblong hole advantageously enables the compensation of translational and rotational deviations. Those deviations are difficult to avoid in manufacturing. Moreover, repair work can be facilitated by releasable variable connections, thus improving sustainability. The same options exist for the roof guide element.

According to the disclosure, at least one of the two toggle lever members/sections can be made of metal or plastic, preferably fiber-reinforced, and can have a solid design or a design with cutouts or a truss construction or a bionic construction.

The disclosure relates to a toggle lever which, in the case of buckling in the area of the positioning guide element, can perform an inward movement, substantially a movement towards the center section or area. This movement enables the movement of the textile fabric by releasing the movement and preferentially ensures, due to the attachment of the textile fabric to the toggle lever, further preferentially to the positioning guide element, in particular the textile fabric to be caught. In this way, in a particularly advantageous manner, the textile is forcibly guided so that it is gently folded and, in particular, does not hang out of the intended area. Thus, the textile fabric of the interior space expansion equipment is allowed to be safely and gently folded in/retracted in an easy-to-use manner which is carried out in particular under real conditions. According to the disclosure, the textile fabric can also be provided to be not connected to the toggle lever and to be manufactured, specifically woven, so that it follows the movement or optional movement released and enabled by the toggle lever.

According to the disclosure, it is an advantageous development of the textile fabric that it is configured to be inflatable and at least double-walled and, thus, is an inflatable double-walled textile fabric which at the same time acts as an operating mechanism. The inflatable function of the textile fabric results from interconnected membranes which are filled with a dedicated fluid, preferably the ambient air, so that the textile fabric assumes the intended inflated shape. In the inflated shape, the textile fabric preferably forms at least one panel section/panel sections which are provided between the roof element/the movable section and the floor element. It is understood that the inflatable textile fabric can be erected by filling with the fluid and can be contracted by draining, particularly exhaustion. It is further understood that bringing the movable section into the folded-in or retracted position is only possible after draining, i.e. when a pliable double-walled textile fabric is provided again. In this state, the textile fabric can move towards the middle section/area of space, and particularly can be pulled into the latter by the toggle lever/toggle levers.

Filling and draining the inflatable textile fabric can advantageously enable the movable section to be brought quickly, specifically taking from 30 sec to 180 sec, preferably from 90 sec to 120 sec, from the retracted/folded-in state into the extended/folded-out state, or vice versa.

In particular, various types of attachment of the textile fabric to the toggle lever, preferably in the area to the positioning guide element thereof, can be implemented. Without being attached, the toggle lever allows the textile fabric to move, for example when the latter is appropriately woven. With existing attachments, the toggle lever ensures forced guidance of the textile fabric, particularly by pulling.

A preferred attachment of the textile fabric to the toggle lever can be made to an inner layer of the textile fabric. This offers the advantageous characteristics that a cross-section, mainly of the inflatable textile fabric, is maintained unchanged and no possibly occurring thermal bridges are formed. Preferentially, an attachment to a continuous point woven out “to zero” of the textile fabric is provided. This offers the advantageous characteristic that the textile fabric is extremely robust and tough in the area of the attachment.

When a section of the textile fabric is woven out “to zero”, this means that one or more of the layers at this point are reduced (tapered) step by step until they disappear substantially completely. In other words, the textile fabric at this point is a single-layer weave.

Particularly preferred, by its at least one panel section/its panel sections, the double-walled inflatable textile fabric provides a pneumatic moving and, resp., operating mechanism for bringing the movable section from its retracted/folded-in position into its extended/folded-out position. The moving and, resp., operating mechanism is not restricted to a pneumatic moving and, resp., operating mechanism, however. Basically, according to the disclosure, any operating mechanism may be provided which is configured to fold out or extend the movable section of the interior space expansion equipment pneumatically, hydraulically or mechanically.

In particular, the disclosure also relates to, specifically single-layer, textile fabrics which cannot act as a pneumatic operating mechanism. Such a configuration can preferentially comprise at least one pneumatic, specifically cylindrical, lifting bellows positioned in the respective corner section(s). The function of the lifting bellows can also be fulfilled equivalently by hydraulic operating mechanisms, specifically hydraulic cylinders, or mechanical operating mechanisms, specifically folding mechanisms.

According to the disclosure, equally at least one lifting bellows can be provided near a toggle lever as a pneumatic operating mechanism. Accordingly, it is understood that the inflatable double-walled textile fabric with its at least one panel section/its panel sections can also be filled with a fluid, particularly redundant to the lifting bellows. Apart from the possible redundancy, in an advantageous manner this ensures additional benefits such as temperature insulation and soundproofing, for example.

Pneumatic or hydraulic operating mechanisms further require an inflation and, resp., draining device which actuates the operating mechanism by generating excess/negative pressure. In the draining device, a draining operation is advantageously reduced, thus improving the user experience. In particular, the same device can be designed and configured as inflation and draining device.

According to the disclosure, all embodiments ensure the enlargement of the accommodation facility interior space and, thus, at the same time an enlargement of the usable space as well as the useful floor space and, resp., the living space and, possibly, also the floor space. It is understood that, in the case of plural interior space expansions, these may be connected to one another and/or to the non-expanded accommodation facility interior space or may not be connected.

According to the disclosure, the textile fabric can comprise one or more sealing edges by which it is connectable to adjacent sections. In particular, keder connections, which are like bead-and-groove connection, beaded edging connection or piping connections can be applied. Apart from a tight connection between adjacent sections, this facilitates, inter alia, the attachment of additional elements, particularly windows and/or doors.

According to a preferred embodiment, a section of the at least one toggle lever member is a bent section or a curved section or a bulged section. At least one of the toggler lever members thus can be referred to as bent/curved/arched toggle lever member. Of preference, in relation to the positioning guide element, i.e. specifically in a direction towards the middle, the section of the at least one toggle lever member is curved away or arched away or bent in a direction away from the positioning guide element to space the toggle lever members apart from each other, specifically in the retracted or folded-in position of the movable section.

Particularly preferred, a section of the at least one toggle lever member is an angled section which is bent specifically in a direction away from the positioning guide element to allow for a spacing. The spacing between the toggle lever members advantageously ensures protection of the textile fabric during the folding operation of the toggle lever, most preferentially also after completion of the folding operation, when the textile fabric assumes a folded state. This spacing is advantageously larger than a, preferentially minimal, safe fold spacing of the textile fabric.

When referring to a safe fold spacing, this means that the folding or folded textile fabric is generally not damaged either within the surfaces or in the region of the folding, e.g. by an inadmissibly high compressive load upon the superimposed textile layers or a too low compressive load upon the superimposed layers by subsequently caused damage by friction. Apart from too small fold spacings, also too large fold spacings result in negative effects, according to the disclosure. A folding space that is too large results, apart from damage to the textile, also in a reduction of the accommodation facility interior space and, resp., in an increase in the outer surface of the accommodation facility due to enlarged external dimensions, with negative aerodynamic effects specifically for vehicles/trailers and, thus, increased energy demand while driving. In other words, defining the safe folding space is an optimization task.

According to the disclosure, the toggle levers may further comprise a fold-in synchronization or a fold-out synchronization. Thus, preferably a fold-in operation of the toggle lever and/or a fold-out operation of the toggle lever can be synchronized. The synchronization can be implemented using Bowden cables and/or shafts and/or levers and/or rods and is intended and configured so that the existing toggle levers move according to a predetermined pattern or synchronously and simultaneously. A preferred embodiment with Bowden cables makes use of the rotation of the guide elements at the toggle lever to synchronize them with other associated guide element(s) at the remaining toggle lever(s). In doing so, the rotation is converted to a translation. Another preferred embodiment makes use of shafts which synchronize, for example via gearwheels, specifically bevel gears, the rotational movements of the various toggle lever guide elements.

In a further embodiment, gearwheels of the fold-in synchronization can equally ensure extension/fold-out of the movable section so that the toggle lever comprises the functions of the fold-in/fold-out synchronization and of the operating mechanism.

According to the disclosure, at least one toggle lever can further comprise a lock. The lock can be operated manually or automatically and prevents the respective toggle lever from moving. The lock can be mounted on the roof guide element and/or on the positioning guide element and/or on the floor guide element to block the corresponding movement. In particular, the lock can comprise a lower lock member which is firmly connected to the lower toggle lever member, an upper lock member which is firmly connected to the upper toggle lever member, and a latch which blocks the relative movement between the two lock members. Consequently, this lock is intended and configured to block the toggle lever by means of a snap-in function. Advantageously, in the extended/folded-out state of the movable section of the interior space expansion equipment a redundant blocking function relative to the operating mechanism can be implemented. During the retracted/folded-in state of the movable section of the interior space expansion equipment, this can advantageously constitute a protection against opening. In other words, this can contribute to burglary protection. Accordingly, it is not excluded that the lock is not intended during other states. On the contrary, during an intermediate state, i.e. between the extended/folded-out and the retracted/folded-in states, a lock can advantageously enable intermediate steps of the interior space expansion. The lock can be implemented by an additional locking lever or locking bar. The disclosure is not limited thereto, however. Furthermore, this blocking function can also be provided by the fold-in synchronization, for example, so that rotations and, resp., translations are blocked. An automatically operable lock which additionally comprises actuating drives or linear drives is preferred.

According to the disclosure, the toggle lever is intended and configured to enable the textile fabric to move inwards to the center section or area. This movement generally results in a constriction of the textile fabric.

The disclosure relates equally preferentially to weave patterns of the textile fabric that promote constriction which constrict and forcibly guide the textile fabric with the support provided by attachment to the toggle lever or exclusively without attachment to the toggle lever. In other words, the function of forced guidance can preferentially be supported by favorable weave patterns. Further preferentially, favorable weave patterns can also exclusively enable the forced guidance, while the toggle lever enables the movement.

According to the disclosure, the panel sections and/or the floor element and/or the roof element can comprise cutouts which are intended and configured to facilitate the mounting of windows, specifically panoramic windows, and doors. Accordingly, the cutouts are not restricted to windows and/or doors, however. The cutouts also may comprise additional gadgets and/or may be provided for holders.

Also, a method is disclosed which comprises the movement of the toggle lever towards a center section or area, when the movable section of the interior space expansion equipment retracts and/or folds in or is retracted and/or folded in. That is because this special movement permits a linked movement of the textile fabric. The disclosure correspondingly also relates to a method of retracting and/or folding in a movable section of an interior space expansion equipment, wherein, when retracting and/or folding in the movable section, at least the following step is carried out: moving a toggle lever arranged on a corner section of the interior space expansion equipment towards a center section or area of an interior space expansion configured and provided by the movable section and a textile fabric, and associated allowing for a movement of the textile fabric towards the center section or area of the interior space expansion, preferably pulling the textile fabric towards the center section or area of the interior space expansion.

It is of advantage when there is an attachment between the toggle lever and the textile fabric, because in this way, as an extension of the afore-described method step, the textile fabric is pulled along by the movement of the toggle lever.

It may be advantageous when a step is carried out which, during movement of a toggle lever arranged at a corner section of the interior space expansion equipment towards a center section or area of an interior space expansion configured and provided by the movable section and a textile fabric allows for a fold-in synchronization, viz. in particular additionally allows for the movement, specifically a predetermined and adjusted movement, of at least one further toggle lever.

It may also be advantageous when a step is carried out which, during movement of a toggle lever arranged at a corner section of the interior space expansion equipment towards a center section or area of an interior space expansion configured and provided by the movable section and a textile fabric allows for a fold-in synchronization, viz. in particular additionally allows for the movement, specifically a predetermined and adjusted movement, of all further toggle levers.

Furthermore, it may be advantageous when a step is carried out which blocks the movement of a toggle lever arranged at a corner section of the interior space expansion equipment by activating a lock. In this way, in a further advantageous manner, the toggle lever can be blocked in a folded-out position, preferably also in a folded-in position. In other words, the toggle lever can be blocked, when the movable section is in the extended and/or folded-out position, but preferentially also, when the movable section is in the retracted and/or folded-in position.

For the rest, the foregoing remarks concerning the device according to the disclosure are applicable mutatis mutandis to the method according to the disclosure.

The disclosure also relates to the use of the afore-described interior space expansion equipment for interior space expansion of an accommodation facility, preferentially a vehicle or a trailer, further preferentially a camper or a camper trailer.

The disclosure moreover relates to an accommodation facility, preferentially a vehicle or a trailer, further preferentially a camper or camper trailer, comprising an afore-described interior space expansion equipment.

### BRIEF DESCRIPTION OF DRAWINGS

In the following, the disclosure shall be illustrated in detail on the basis of Figures, wherein:

FIG. 1 shows a perspective view of an interior space expansion equipment according to the disclosure in the embodiment on a vehicle roof;

FIG. 2 shows a perspective view of the extended/folded-out interior space expansion equipment according to the disclosure having a bottom cutout as well as a fold-in synchronization and a lock of a toggle lever, wherein a textile fabric of the interior space expansion equipment according to the disclosure was omitted for illustration purposes;

FIG. 3 shows a perspective view of an interior space expansion equipment according to the disclosure in an intermediate state;

FIG. 4 shows a side/sectional view of a toggle lever with attachment to a textile fabric of the interior space expansion equipment according to the disclosure in an intermediate state;

FIG. 5 shows a side/sectional view of the toggle lever with attachment to the textile fabric of the interior space expansion equipment according to the disclosure in a further intermediate state;

FIG. 6 shows a side/sectional view of the toggle lever with attachment to the textile fabric of the interior space expansion equipment according to the disclosure in yet another intermediate state;

FIG. 7 shows a side/sectional view of a toggle lever without attachment to a textile fabric of an interior space expansion equipment according to the disclosure in an extended/folded-out state;

FIG. 8 shows a side/sectional view of a toggle lever with attachment to an inner layer of a textile fabric of an interior space expansion equipment according to the disclosure in an extended/folded-out state;

FIG. 9 shows a side/sectional view of a toggle lever with an attachment continuously woven out “to zero” to a textile fabric of an interior space expansion equipment according to the disclosure in an extended/folded-out state; and

FIG. 10 shows a perspective view of an interior space expansion equipment according to the disclosure with a textile fabric in an intermediate state.

The Figures are only schematic and serve solely to provide a better understanding of the disclosure. Like elements are marked with the same reference signs. The features of the individual embodiments can be exchanged with one another.

### DETAILED DESCRIPTION OF THE PREFERRED EMBODIMENTS

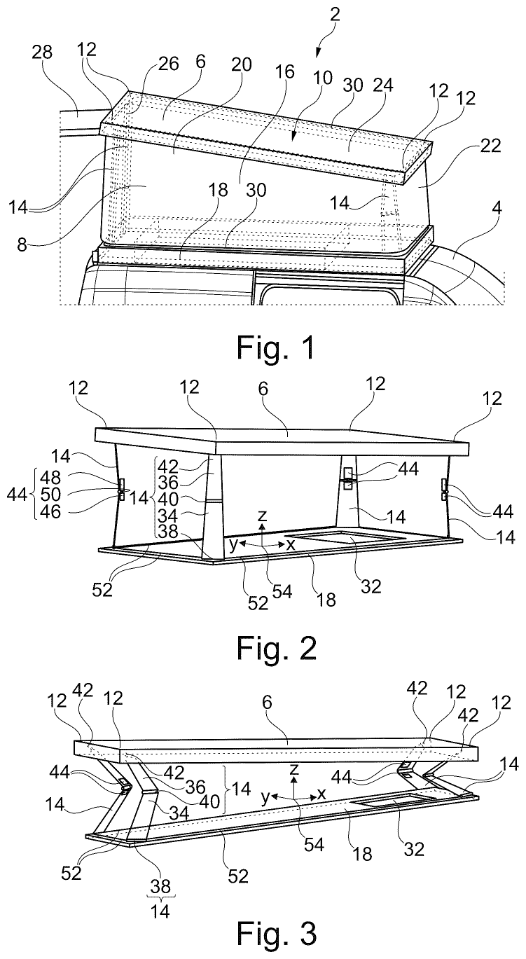

FIG. 1 shows an embodiment of an interior space expansion equipment 2 according to the disclosure for a vehicle 4 in a perspective view slanted from above. The interior space expansion equipment 2 includes a movable section 6 which is brought into a shown extended and folded-out position, and a spanned textile fabric 8 which together with the movable section 6 forms/provides an interior space expansion 10. Further, the interior space expansion equipment 2 has four toggle levers 14 arranged at the corner sections 12. It can be seen that the toggle levers 14 are rotated and arranged in the direction of a center section or area 16. This enables the movement of the toggle levers 14 and the textile fabric 8 towards the center section or area 16, when the movable section 6 is brought from the shown extended and folded-out position into a retracted and folded-in position. In the illustrated embodiment, a combined movement is provided when moving from the retracted and folded-in position to the extended and folded-out position, as the front toggle levers 14 in the driving direction—in the specific example-are shorter in a stretched position than the rear toggle levers 14, and thus a rotational and translational movement component is provided, when the movable section 6 is brought from the retracted and folded-in position into the extended and folded-out position.

In FIG. 1, the toggle levers 14 are on the inside with respect to the spanned space which is located between the movable section 6 and the textile fabric 8. In other words, the toggle levers 14 are located inside the interior space expansion 10. Yet in other words, the toggle levers 14 cannot be recognized by an external observer. It should be noted at this point that the interior space expansion equipment 2 shown in FIG. 1 has an appealing design mainly due to the external spanned textile fabric 8.

Further, the embodiment in FIG. 1 includes a floor element 18 which is fastened on the vehicle 4. Said floor element 18 creates, together with the movable section 6, the delimiting surfaces between which the textile fabric 8 is spanned with the four panel sections 20, 22, 24, 26 thereof.

Furthermore, the floor element 18 allows for a modular design of the interior space expansion equipment 2. Consequently, the module of the interior space expansion equipment 2 can be mounted as a whole to the vehicle 4.

Moreover, a load-bearing surface which distributes the loads occurring during use of the interior space expansion 10 is preferentially formed by the floor element 18.

It is understood that the floor element 18 can also include on or more openings and a frame open to the bottom also constitutes a floor element 18. Just as well, the floor element 18 can be a slatted frame. Therefore, the floor element 18 does not necessarily have to be a load-bearing surface.

In addition, FIG. 1 shows a folded-out door/window element 28 that is arranged on the rear panel section 26 in the driving direction of the interior space expansion equipment 2. Advantageously, this enables entry and exit in the case of a door element or natural ventilation in the case of a window element.

Diverse sealing edges 30, preferably in the form of keder connections, are shown in FIG. 1. This makes it possible to tightly connect divided sections.

It is clear, as a matter of course, that the connection to the vehicle 4 is enabled at the load-bearing sections thereof, preferably at the chassis and body thereof.

The movement of the knee lever 14 is illustrated in FIG. 2 and FIG. 3. Accordingly, in each case a perspective side view of the interior space expansion equipment 2 according to the disclosure is shown, but without a textile fabric 8. In this way, the structure and the movement of the toggle lever can be advantageously understood.

The embodiment shown in FIG. 2 comprises the four toggle levers 14 which are arranged in the corner positions 12 between the movable section 6 and the floor element 18 having a cutout 32, a lock 44 at the toggle levers 14 and a fold-in synchronization 52 between the toggle levers 14. For the purpose of illustration, a coordinate system 54 is introduced.

The cutout 32 of the floor element 18 is intended and configured to connect the interior space expansion 10 to a vehicle interior. This allows for comfortable access between the vehicle interior and the interior space expansion 10. The cutout 32 is shown to be relatively small in the Figure, but, according to the disclosure, it can also extend over the whole floor space, for example when the floor element 18 substantially is a frame open to the bottom.

A (single) toggle lever 14 comprises a lower toggle lever member 34, an upper toggle lever member 36, a floor guide element 38, a positioning guide element 40 and a roof guide element 42 covered in the perspective view.

The lock 44 mounted on a (single) toggle lever 14 includes a lower lock member 46, an upper lock member 48 and a latch 50.

FIG. 2 makes clear that the toggle levers 14 are not completely stretched and not overstretched, although the movable section 6 of the interior space expansion equipment 2 according to the disclosure is brought into an extended and/or folded-out position. Advantageously, this allows to immediately fold in the toggle levers 14. In other words, a toggle lever 14 moves towards the center section or area 16 solely due to the effect of gravity. This immediately occurring movement can be prevented by using a lock 44 so that a toggle lever 14 can transmit a normal force in the z direction of the coordinate system 54, with possibly occurring transverse forces, when the lock 44 blocks the movement. Such a blocking function of the lock 44 is facilitated, when the latch 50 connects the lower lock member 46 to the upper lock member 48, as exemplified. It is understood that the toggle lever 14 can also be overstretched according to the disclosure, wherein in such case manual intervention or provision of an appropriate release mechanism would be necessary, however.

The fold-in synchronization 52 comprises plural shafts and allows torques to be transmitted between the toggle levers 14. In this way, the movement of the toggle levers 14 is advantageously set in a predetermined manner so that they move coherently and jointly. Diverse load and moment transmitting connections, particularly interposed gearings, of the fold-in synchronization 52 to the toggle levers 14 can help determine the movement thereof. As an alternative to shafts, also cables or rods are conceivable.

FIG. 3 illustrates a perspective side view of an interior space expansion equipment 2 according to the disclosure in a retracting/folding-in intermediate state. The movement of the toggle levers 14 towards the center section or area 16 is clearly demonstrated. In the following, only the differences from FIG. 2 shall be described.

The toggle levers 14 are folded to a different degree, which is facilitated by the fold-in synchronization 52. Since the toggle levers fold in differently, the movable section 6 performs a combined movement consisting of translational and rotational movement components.

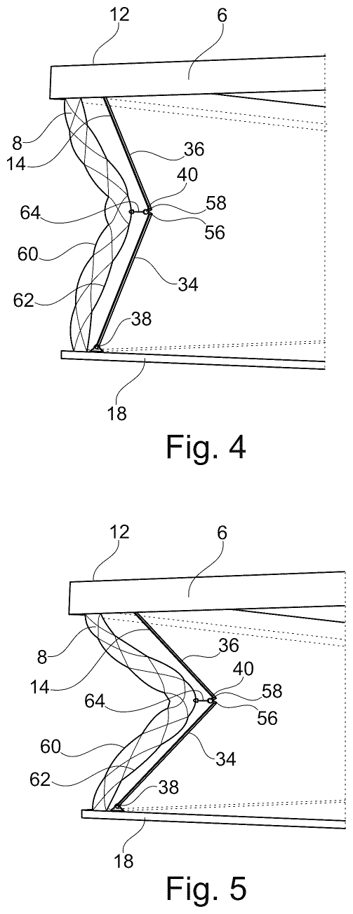

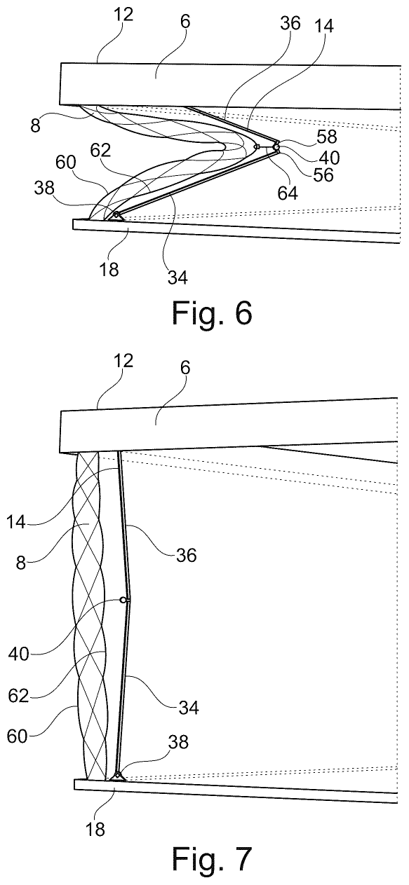

FIG. 4, FIG. 5 and FIG. 6 illustrate the movement of a toggle lever 14 in a two-dimensional view. The section plane of the representations in each case is located centrally along the longitudinal axis of the respective toggle lever 14. The toggle lever 14 is connected to the textile fabric 8 so that, when the toggle lever 14 moves towards the center section or area 16, the textile fabric 8 is pulled towards the center section or area 16. In the Figures, an inflatable double-walled textile fabric 8 is shown.

Said toggle lever 14 comprises, according to the depicted embodiment, a bent section 56 at the lower toggle lever member 34 and another bent section 58 at the upper toggle lever member 36. Each of said bent sections is located on the side facing the positioning guide element 40. Advantageously, this allows for a spacing between the lower toggle lever member 34 and the upper toggle lever member 36, above all when they are substantially in parallel to each other. Such a position of the toggle lever members 34, 36 substantially in parallel to each other occurs when the movable section 6 is brought in to a retracted and/or folded-in position. Said spacing is intended and configured to prevent the textile fabric 8 from undercutting a minimum folding space in order to fold the textile fabric 8 particularly gently and, thus, to allow for sustainable use.

In this embodiment, the textile fabric 8 is an inflatable textile fabric 8 which can be filled with a fluid, preferably the ambient air. The textile fabric 8 comprises an outer layer 60 facing the exterior and an inner layer 62 facing the center section or area.

The toggle lever 8 is connected to the inner layer 62 via an attachment 64.

In FIG. 5 and FIG. 6, the toggle lever 14 moves continuously in the direction of the center section or area 16. Accordingly, it is particularly illustrated how the textile fabric is pulled and how the spacing is formed.

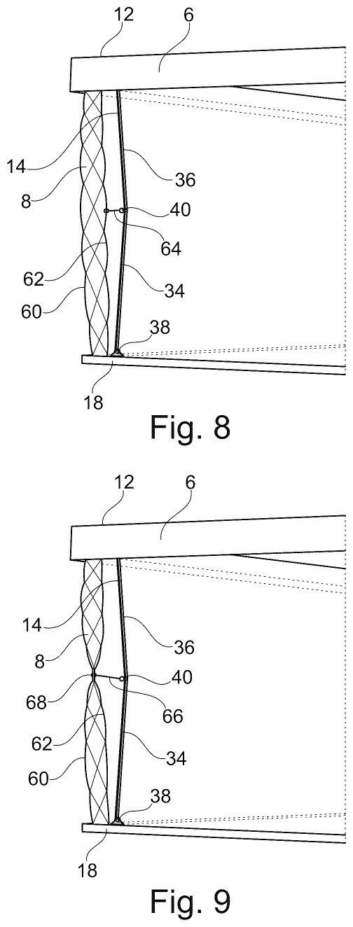

FIG. 7, FIG. 8 and FIG. 9 show three embodiments in a two-dimensional view. The section plane of each of the representations is located centrally along the longitudinal axis of the respective toggle lever 14. The three embodiments illustrate no attachment and the attachments 64, 66 (types of attachments) which connect the textile fabric 8 to the toggle lever 14 at the positioning guide element 40. In the following, only the differences from FIG. 4, FIG. 5 and FIG. 6 shall be described.

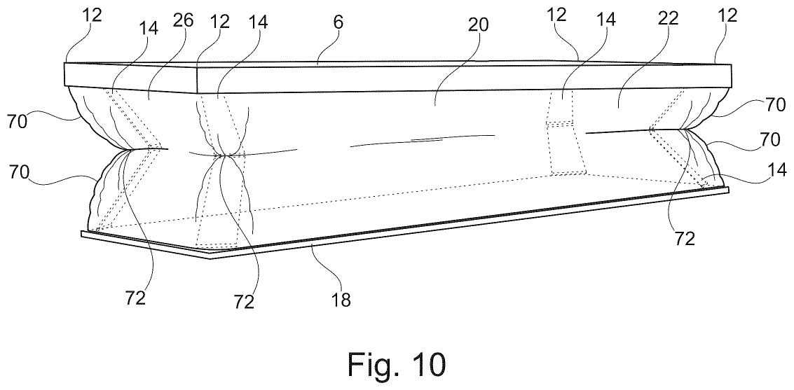

FIG. 7 represents no attachment between the textile fabric 8 and the toggle lever 14. In this way, the toggle lever 14 allows the textile fabric 8 to move by the release of moving space which the toggle lever 14 otherwise would block. This is of particular advantage when the textile fabric 8 has a specific weaving pattern 70, as indicated in FIG. 10, and constricts itself in a specific manner while it moves towards the center section or area 16.

FIG. 8 shows an attachment 64 of the textile fabric 8 between the inner layer 62 and the positioning guide element 40 of the toggle lever 14. It can be seen that the cross-section of the textile fabric 8 remains the same despite the attachment 64 and, therefore, also maintains substantially constant characteristics. Because of the attachment, the toggle lever 14 allows for the movement of the textile fabric 8 and pulls the latter towards the center section or area 16.

FIG. 9 shows an attachment 66 of the textile fabric 8 between the section 68 woven out “to zero” and the positioning guide element 40 of the toggle lever 14. Here one can see that the cross-section of the textile fabric 8 narrows in the area of the woven-out point 68 to allow for an extremely robust and tough connection. Because of the woven-out attachment 68, the toggle lever 14 allows for the movement of the textile fabric 8 and pulls the latter towards a center section or area, analogously to FIG. 8.

FIG. 10 represents a perspective view slanted from above of an embodiment of an interior space expansion equipment 2 according to the disclosure which comprises four toggle levers 14, a movable section 6, a floor element 18 and four panel sections 20, 22, 24, 26. The panel sections 20, 22, 24, 26 include an inflatable, particularly at least double-walled textile fabric 8 as material which deforms inward on its own by means of the specific weaving pattern 70, when it moves towards the retracted and/or folded-in position of the movable section 6. This inward deformation on its own may occur in support of the attachment 64, 66 to the toggle lever 14 and/or may occur solely when no attachment to the toggle lever 14 is provided. The textile fabric forms a constriction 72 which occurs analogously to the movement of the knee lever 14 towards the center section or area.

If the textile fabric 8 is not inflatable, preferentially an attachment 64, 66 is provided so that said non-inflatable textile fabric 8 is pulled from the toggle lever 14 towards the center section or area.

1. An interior space expansion equipment which is arranged or arrangeable on an accommodation facility, comprising:
a movable section which is capable to be brought both into an extended and/or folded-out position and into a retracted and/or folded-in position; and
a textile fabric which, in the extended and/or folded-out position of the movable section, together with the movable section forms and/or provides an interior space expansion of the accommodation facility, wherein
the interior space expansion equipment further comprises a toggle lever which is arranged on a corner section of the interior space expansion equipment and, when the movable section is brought into the retracted and/or folded-in position, performs a movement towards a center section or area of the interior space expansion and enables movement of the textile fabric towards the center section or area of the interior space expansion.

2. The interior space expansion equipment according to claim 1, wherein the toggle lever or—in the event of plural intended toggle levers—the toggle levers is/are arranged completely inside the interior space expansion.

3. The interior space expansion equipment according to claim 1, wherein it comprises a plurality of toggle levers, which are arranged at respective corner sections of the interior space expansion equipment and each of which, when the movable section is brought into the retracted and/or folded-in position, performs a movement towards the center section or area of the interior space expansion and enables a movement of the textile fabric towards the center section or area of the interior space expansion.

4. The interior space expansion equipment according to claim 1, wherein the textile fabric is inflatable and at least double-walled.

5. The interior space expansion equipment according to claim 4, wherein the inflatable at least double-walled textile fabric is intended and configured to ensure, as a pneumatic operating mechanism, the movable section of the interior space expansion equipment to be extended and/or folded out.

6. The interior space expansion equipment according to claim 1, wherein the textile fabric includes at least one attachment to the toggle lever which is intended and configured to pull the textile fabric towards the center section or area of the interior space expansion.

7. The interior space expansion equipment according to claim 6, wherein the textile fabric includes at least one attachment to the toggle lever, wherein the attachment is made to an inner layer of the textile fabric and/or the attachment is made to a section woven out “to zero” of the textile fabric.

8. The interior space expansion equipment according to claim 1, wherein the toggle lever is not completely stretched and is not overstretched in the extended and/or folded-out position of the movable section so that it is intended and configured to retract and/or fold in under the sole effect of gravity.

9. The interior space expansion equipment according to claim 1, wherein the toggle lever comprises two toggle lever members and a positioning guide element, and wherein the toggle lever is intended and configured so that a minimum folding space between the toggle lever members is not undercut in the retracted and/or folded-in position of the movable section.

10. The interior space expansion equipment according to claim 9, wherein at least one of the two toggle lever members is curved, at the end aligned with a positioning guide element located between the toggle lever members so that a resulting spacing between the toggle lever members in the retracted and/or folded-in position of the movable section does not undercut a minimum folding space.

11. The interior space expansion equipment according to claim 1, wherein the toggle lever further comprises a fold-in synchronization which comprises Bowden cables and/or shafts and is intended and configured so that plural intended toggle levers move according to a predetermined pattern or synchronously and simultaneously.

12. The interior space expansion equipment according to claim 1, wherein the toggle lever further comprises a lock which is intended and configured to perform a snap-in function.

13. The interior space expansion equipment according to claim 1, wherein the accommodation facility is a vehicle or a trailer.

14. The interior space expansion equipment according to claim 1, wherein the accommodation facility is a camper or camper trailer.

15. The interior space expansion equipement according to claim 1, wherein the toggle lever is arranged on a corner section of the interior space expansion equipment and, when the movable section is brought into the retracted and/or folded-in position, performs a movement towards a center section or area of the interior space expansion and enables movement of the textile fabric towards the center section or area of the interior space expansion and pulls the textile fabric towards the center section or area of the interior space expansion.

16. The interior space expansion equipement according to claim 3, wherein the plurality of toggle levers are four toggle levers.

17. A method of retracting and/or folding in a movable section of an interior space expansion equipement, wherein, when retracting and/or folding in the movable section, at least the folling step is performed:
moving a toggle lever arranged at a corner section of the interior space expansion equipement towards a center seciton or area of an interior space expansion formed and/or provided by the movable section and a textile fabric, and associated allowaing for a movement of the textile fabric towards the center section or area of the interior space expansion.

18. The method according to claim 17, wherein, when retracting and/or folding in the movable section, at least the following step is performed:
moving a toggle lever arranged at a corner section of the interior space expansion equipment towards a center section or area of an interior space expansion formed and/or provided by the movable section and a textile fabric, and associated allowing for a movement of the textile fabric towards the center section or area of the interior space expansion, and pulling the textile fabric towards the center section or area of the interior space expansion.

19. A use of the interior space expansion equipment according to claim 1 for interior space expansion of an accommodation facility.

20. An accommodation facility, comprising an interior space expansion equipment according to claim 1.
